(19) United States
(12) Patent Application Publication
(10) Pub. No.: US 2005/0210205 A1
(43) Pub. Date: Sep. 22, 2005

(54) METHOD FOR EMPLOYING MEMORY WITH DEFECTIVE SECTIONS

(76) Inventors: Chang-Lien Wu, Tai-Chung City (TW); Chih-Ching Wang, Tai-Chung Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,636

(22) Filed: Mar. 17, 2004

(51) Int. Cl. G06F 12/00

(52) U.S. Cl. 711/154

(57) ABSTRACT

A method for forming a linked list with defective memory in an electronic device is disclosed. The method includes the steps of: performing at least a built-in self test (BIST) on a memory of the electronic device; and forming or updating the linked list of the electronic device according to at least a result of the BIST; whereby the linked list of the electronic device does not correspond to any defective memory sections.

### BACKGROUND OF INVENTION

1. Field of the Invention

The invention relates to a method for using a memory, and more particularly to a method for using a memory having defective sections in an electronic device.

2. Description of the Prior Art

Electronic devices for network communication purpose, such as switches, routers, or the like, employ memory as packet buffers for buffering packets in transmission. A packet buffer is usually segmented into sub-blocks, where these sub-blocks are designated as “pages”. In order to manage the pages of the packet buffer, a data structure termed as a “linked list” and usually maintained in a separate memory block called a “header table”, is conventionally utilized. Conceptually, a linked list contains entries, wherein each entry is associated with one page of the packet buffer. Thus, an entry of the linked list usually comprises a pointer to the current page, as well as a pointer to the entry of the linked list associated with the next page. In such a way, the pages of the packet buffer are “linked” by using the linked list.

For simplicity of explanation, please refer to FIG. 1 showing a linked list with 8 entries. As shown in FIG. 1, the linked list with 8 entries includes a first pointer field corresponding to the pointers to the current page of an associated packet buffer (not shown), and a second pointer field corresponding to the entry associated with the next page. Take Entry 4 as an example; it is shown in FIG. 1 that the first pointer of Entry 4 corresponds to a current page (Page 4) of the packet buffer, and the second pointer of Entry 4 corresponds to the entry associated with the next page, which is Entry 5 in this case. This same manner of association can be seen for each entry of the linked list.

It is therefore clear by the nature of a linked list that if there exists any defects in any of the pages of the packet buffer or in any of the sections of the header table storing entries of the linked list, the electronic device will have trouble performing originally designed function. In other words, it is not desirable to have defective memory blocks employed as the packet buffer or the header table in an electronic device.

### SUMMARY OF INVENTION

It is therefore one of the many objectives of the claimed invention to provide a method for using a memory associated with a linked list and having defective sections in an electronic device.

According to the claimed invention, a method for forming a linked list with defective memory in an electronic device is disclosed. The method comprises the steps of: performing at least a built-in self test (BIST) on a memory of the electronic device; and forming or updating the linked list of the electronic device according to at least a result of the BIST; whereby the linked list of the electronic device does not correspond to any defective memory sections.

One of the many advantages of the claimed invention is the ability to use defective memory to provide the function of a linked list. Given this ability, manufacturers will be able to increase the yield of usable memory for every batch of memory fabricated. As a result, efficiency should increase and costs decrease.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a structural diagram of a linked list.

FIG. 2 is a diagram of an electronic device using memory associated with a linked list and having defective sections according to an embodiment of the present invention.

FIG. 3 is a flowchart of the method employed by the electronic device in FIG. 2 when the test result memory is not present.

FIG. 4 is a diagram of a linked list, updated after a defective section in the header table is found.

FIG. 5 is a diagram of the linked list, updated after a defective page in the packet buffer is found.

FIG. 6 is a flowchart of the method employed by the electronic device in FIG. 2 when the test result memory is present.

### DETAILED DESCRIPTION

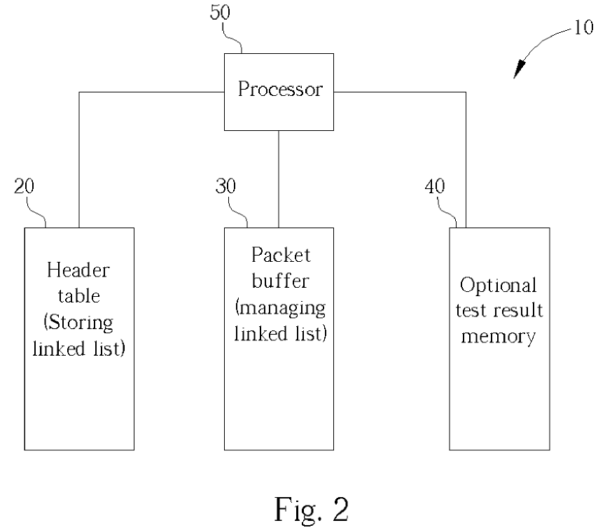

Please refer to FIG. 2. FIG. 2 is a diagram of an electronic device 10 using memory associated with a linked list and having defective sections according to an embodiment of the present invention. In this embodiment, the electronic device 10 comprises a header table 20 for storing the linked list, a packet buffer 30 that has pages corresponding to entries in the linked list, and a processor 50 coupled to the memories for manipulating the memories. Optionally, the electronic device 10 may further comprise a test result memory 40 for recording the results of a built-in self test (BIST).

The electronic device 10 can be embodied by but not limited to a switch, a router, or the like. The header table 20 as well as the packet buffer 30 can be embodied by but not limited to SRAM memory. The test result memory 40 can be embodied by but not limited to registers. The embodiments of these parts are merely to serve as examples and are not meant to act as limitations. In this written description, the specification will refer to the parts of the invention by their given examples.

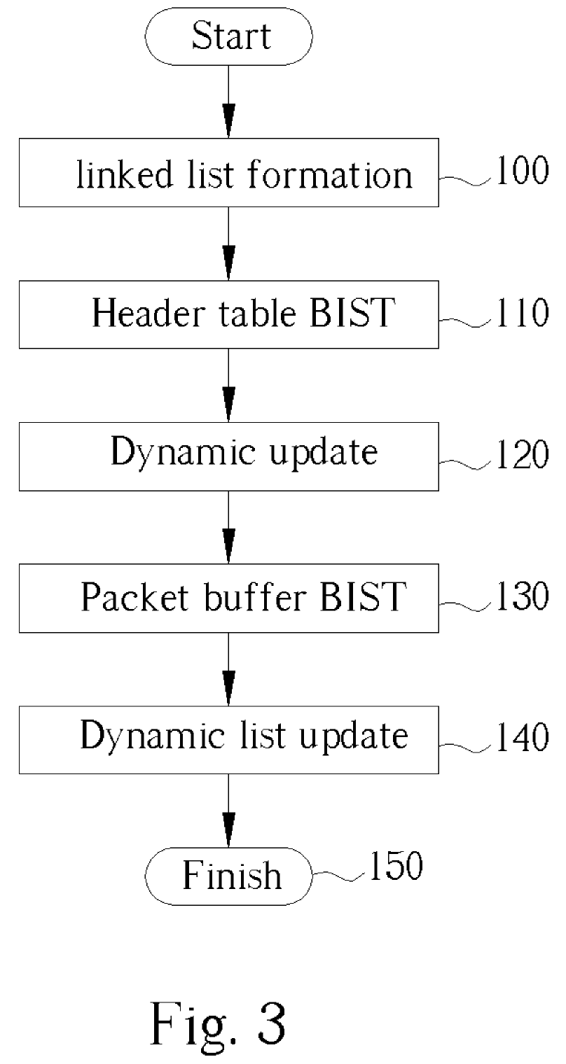

Please refer to FIG. 3. FIG. 3 is a flowchart of the method employed by the electronic device in FIG. 2 when the test result memory 40 is not present according to one embodiment of the present invention. Please note that the method shown in the flowchart of FIG. 3 usually occurs after the switch 10 has been turned on. This, however, should not be taken as a limitation. As for details concerning the built-in self test (BIST), please refer to “a programmable BIST core for embedded DRAM”, by Huang et. al., IEEE Design and Test Magazine, January-March 1999, which is incorporated by reference herein.

Step 100: Linked List Formation. The switch 10 forms a linked list. In this embodiment, all sections in the header table 20 are used.

Step 110: Header table BIST. The switch 10 performs a BIST on the header table 20. The purpose of the BIST is to determine which sections of the header table 20 are defective.

Step 120: Dynamic Update. The switch 10 dynamically updates the linked list as Step 110 is being done. Each time a defective section is found in the header table 20, the switch 10 will pause the BIST, update the linked list dynamically so as not to use the defective section in the list, and then continue the BIST. As a result, the linked list will be updated to exclude the use of the defective sections of the header table 20 in storing the linked list.

Step 130: Packet buffer BIST. The switch 10 performs a BIST on the packet buffer 30. The purpose of the BIST is to determine which pages of the packet buffer 30 are defective.

Step 140: Dynamic Update. The switch 10 dynamically updates the linked list as Step 130 is being done. Each time a defective page is found in the packet buffer 30, the switch 10 will pause the BIST, update the linked list dynamically so as not to use the section corresponding to the defective page of the packet buffer 30, and then continue the BIST. As a result, the linked list will be updated to exclude the use of the sections of the header table 20 corresponding to the defective pages in its linking.

Step 150: Finish. The switch 10 now has a healthy linked list free of any association with defective memory sections.

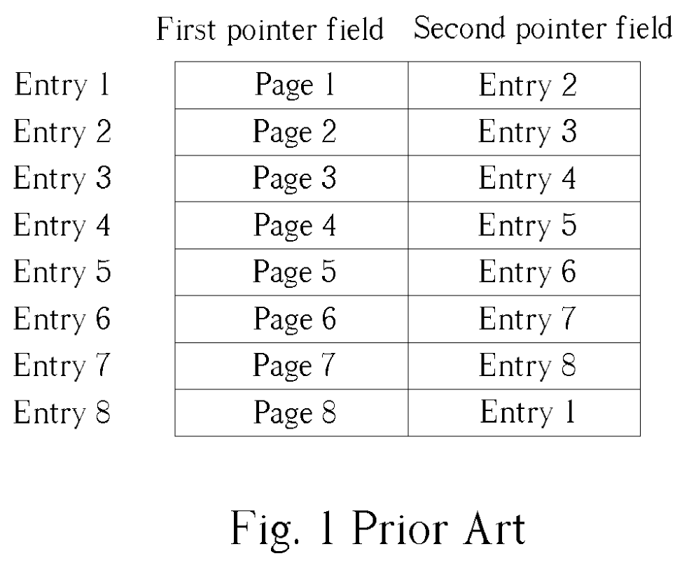

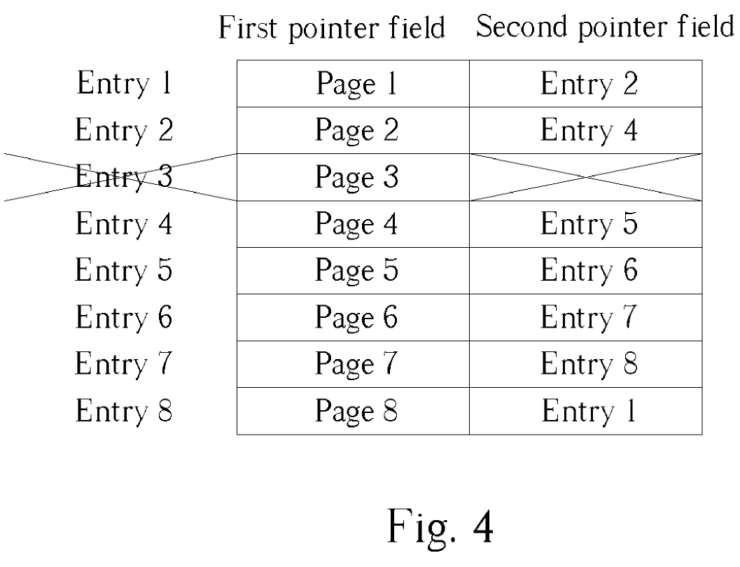

Now take the 8-entry linked list in FIG. 1 as an example for explanatory purpose. After the linked list formation in Step 100, a linked list as shown in FIG. 1 can be established. Then Steps 110 and 120 are performed. If in this example a section of the header table 20 corresponding to Entry 3 of the linked list is found to be defective, the method will then dynamically update the linked list to a state as shown in FIG. 4, which illustrates a crossed-out Entry 3 and the second pointer field thereof to indicate a defective section of the header table 20. Please note that the second pointer field of Entry 2 is accordingly updated to point to Entry 4 in order to exclude the use of the defective section of the header table 20.

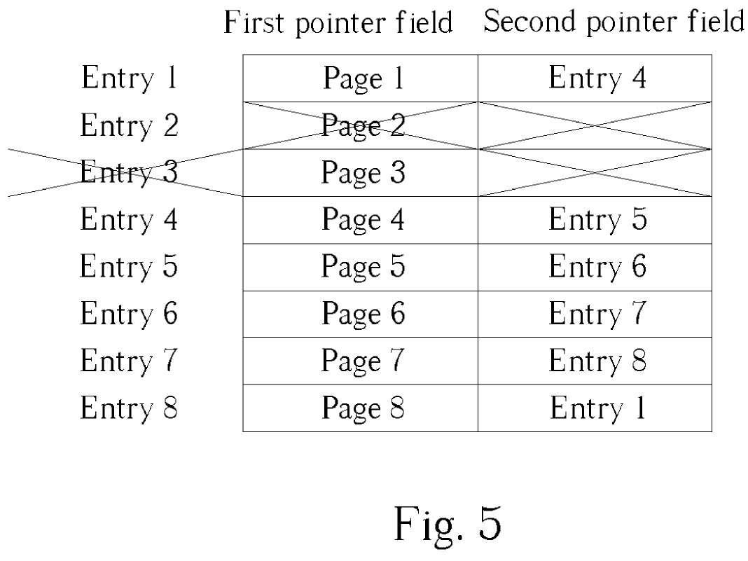

Later when it comes to Steps 130 and 140, if in this example a page of the packet buffer 30 corresponding to Entry 2 of the linked list is found to be defective, the method will then dynamically update the linked list to a state as shown in FIG. 5, which further illustrates a crossed-out Page 2 in the first pointer field and the second pointer field thereof to indicate a defective page of the packet buffer 30. Please note that the second pointer field of Entry 1 is accordingly updated to point to Entry 4 in order to exclude the use of the defective page of the header table 30. As a result in Step 150, the switch 10 will have a healthy linked list free of any association with defective memory sections as shown in FIG. 5.

Please note, that the BIST and associated dynamic updating of the packet buffer 30 can take place before the BIST and associated dynamic updating of the header table 20 if so desired. That is, the order of the steps illustrated in the flowchart of FIG. 3 is not meant to serve as limitation. Also note that the number of the entries in the linked list as illustrated in the aforementioned description and figures is presented only for example and is not meant to limit.

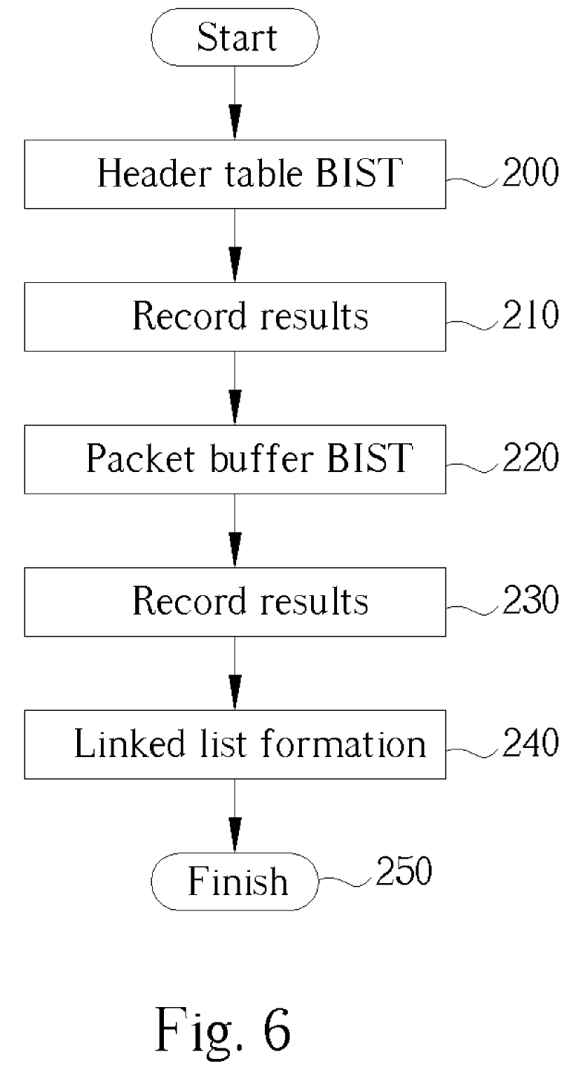

Please refer to FIG. 6. FIG. 6 is a flowchart of the method employed by the electronic device 10 in FIG. 2 when test result memory 40 is present according to another embodiment of the present invention.

Step 200: Header table BIST. The switch 10 performs a BIST on the header table 20. The purpose of the BIST is to determine which sections of the header table 20 are defective.

Step 210: Record the results. The results from the header table BIST are recorded into the test result memory 40. These results will later be used to determine how to form the linked list.

Step 220: Packet buffer BIST. The switch 10 performs a BIST on the packet buffer 30. The purpose of the BIST is to determine which pages of the packet buffer 30 are defective.

Step 230: Record the results. The results from the header table BIST are recorded into the test result memory 40. These results will later be used to determine how to form the linked list.

Step 240: Linked List Formation. Using the results stored in the test result memory 40, the switch 10 is able to avoid the use of defective sections and pages when forming a linked list.

Step 250: Finish. The switch 10 now has a healthy linked list free of any association with defective memory sections.

To contrast the methods presented in FIG. 3 and FIG. 6, the method in FIG. 3 forms a linked list first and later updates the linked list dynamically according to BIST results. On the other hand, the method in FIG. 6 first records all the BIST results and then forms the linked list according to the recorded BIST results. The method in FIG. 6 may be implemented so that the hardware is simpler but with a smaller number of tolerable defective pages. In contrast, the method in FIG. 3 may tolerate an arbitrary number of defective pages, while the hardware complexity is higher.

Please note that for both processes in FIG. 3 and FIG. 6, the BIST on either memory is not limited to being run only once but can be run as many times as desired before moving on to the next step. Also, please note, that the present invention does not limit the BIST to having to be run on both the header table 20 and the packet buffer 30. A designer can choose to have the BIST run only on one of the memories and still be within the spirit of the invention.

Please also note that the linked list in FIG. 1 and the associated header table 20 thereof according to another embodiment of the present invention may even comprise an additional third pointer field and corresponding memory sections, respectively, for storing pointers in a reversed fashion as those in the second pointer field. By doing so, the linked list in this embodiment has a bi-directional characteristic. Since the present invention method of employing defective memory can be implemented in such a bi-directional linked list in a manner similar to what has been disclosed in the aforementioned written descriptions and drawings, further explanations are hereby omitted.

As one can see, the present invention allows manufacturers to use memory with defective sections for implementing the function of a linked list. Furthermore, the linked list of the present invention is not affected by defective sections present in the memories associated with the linked list. As a result, manufacturers will be able to increase the yield of usable chips each time they fabricate memory, leading to increased productivity and lowered costs.

Those skilled in the art will readily observe that numerous modifications and alterations of the device may be made while retaining the teachings of the invention. Accordingly, that above disclosure should be construed as limited only by the metes and bounds of the appended claims.

1. A method for forming a linked list with a memory in an electronic device, comprising:
performing a built-in self test (BIST) on the memory; and
forming the linked list according to a result of the BIST;
wherein if the memory includes a defective section, the linked list does not have a correspondence to the defective section.

2. The method of claim 1 further comprising:
storing the result of the BIST into a test result memory.

3. The method of claim 1 wherein the linked list is dynamically updated as long as the defective section is detected through performing the BIST on the memory.

4. The method of claim 1 wherein the memory, which the BIST is performed on, is a header table for storing the linked list.

5. The method of claim 1 wherein the memory, which the BIST is performed on, is a packet buffer which the linked list points to.

6. The method of claim 1, wherein the electronic device is a switch.

7. The method of claim 1, wherein the electronic device is a router.

8. A method for forming a linked list with memory in an electronic device, comprising:
performing a built-in self test (BIST) on a header table of the electronic device;
performing a BIST on a packet buffer of the electronic device; and
forming the linked list of the electronic device according to at least a result of the BISTs;
wherein if at least one of the header table and the packet buffer includes a defective storage portion, the linked list does not have a correspondence to the defective storage portion.

9. The method of claim 8 further comprising:
storing the result of at least one of the BISTs into a test result memory.

10. The method of claim 8 wherein the linked list is dynamically updated as long as the defective storage portion is detected through performing the BIST on the header table or the packet buffer.

11. The method of claim 8 wherein the electronic device is a switch.

12. The method of claim 8 wherein the electronic device is a router.
